(19) United States
(12) Patent Application Publication
(10) Pub. No.: US 2005/0080683 A1
(43) Pub. Date: Apr. 14, 2005

(54) Administering a virtual shopping list for a user

(75) Inventor: Lauren Bell Jordan, League City, TX (US)

Correspondence Address: IBM CORP (BLF), c/o BIGGERS & OHANIAN, LLP, 504 LAVACA STREET, SUITE 970, AUSTIN, TX, 78701-2856, US

(73) Assignee: INTERNATIONAL BUSINESS MACHINES CORPORATION, Armonk, NY (US)

(21) Appl. No.: 10/682,388

(22) Filed: Oct. 9, 2003

(51) Int. Cl. G06F 17/60

(52) U.S. Cl. 705/26

(57) ABSTRACT

A method, system and computer program product is provided for administering a shopping list for a user. A shopping list can be created online and items can be added or deleted to the shopping list by a user. A retailer can administer the list to prioritize certain items within the shopping list for the user, insert coupons to the shopping list for use by the user when the user shops, highlight sale items within the shopping list, suggest alternative items for the user, and the like.

### BACKGROUND OF THE INVENTION

1. Field of the Invention

The field of the invention is data processing, or, more specifically, methods, systems, and products for administering a shopping list for a user.

2. Description of Related Art

Retailers are constantly trying new ways to attract customers' attention and gain loyal customers. One way that stores attempt to attract customers and gain their loyalty is through the use of store cards that offer bonus programs and in-store coupons for customers carrying the card when they shop at that store. Store cards are popular among grocery stores. Although many customers register for store cards offering bonuses and discounts, they often forget to bring the cards with them to the store. Furthermore, store cards do not give retailers information about which items the customer is planning on purchasing.

Another way stores attempt to attract customers and gain their loyalty is through print advertising. Many stores provide manufacturer coupons and store coupons in printed and packaged mailers that are mailed to a random audience. Although many customers clip coupons from random mailers, a great many customers forget to bring the coupons to the store. As with store cards, printed coupons also do not give a retailer information about which items the customer is planning on purchasing.

Customers also have less and less time and energy to spend shopping. Even conscientious customers who create a shopping list to improve their shopping efficiency often forget the list, omit an item from the list, or include an item in the list that is not sold at that store. Furthermore, retailers are not privy to the user's shopping list and therefore do not know which items a user is planning to purchase.

Store cards and random coupon mailers do not provide retailers with customer loyalty, and do not make shopping efficient for customers. Furthermore, these conventional techniques do not provide a retailer with knowledge of who their customers are, what items their customers want to purchase, and their customers' purchase history indicating routine purchasing patterns. Store cards and random coupon mailers also fail to make shopping efficient for customers. There is therefore a need for a method, system, and computer product that provides retailers and manufacturers alike with knowledge concerning their customers, their specific needs, and makes shopping more efficient for the user.

### SUMMARY OF THE INVENTION

A method, system, and computer program product is provided for administering a shopping list for a user. The shopping list is typically a data structure that includes a list of shopping items and that is typically available at the store for the user's use while shopping. A shopping list can be created online and items can be added or deleted to the shopping list by a user. A retailer can administer the list to prioritize certain items within the shopping list for the user, insert coupons to the shopping list for use by the user when the user shops, highlight sale items within the shopping list, suggest alternative items for the user, and the like.

In many exemplary embodiments, a shopping list is created in dependence upon a user purchase history. A user purchase history is a data structure representing a previous shopping experience for the user. Such a user purchase history typically includes a list of items previously purchased. In various embodiments, user purchase histories are used as a base shopping list that facilitate a user creating a current shopping list for a particular shopping trip. User purchase histories can also be used as a default shopping list if the user has not created a current shopping list for a particular shopping trip.

Shopping lists advantageously provide retailers with information concerning their customers and a vehicle to specifically market to those customers. Shopping lists also advantageously provide a user with a vehicle to improve their shopping efficiency and an incentive to shop at a retailer who provides the shopping list service.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram of exemplary computer architecture useful in implementing methods for administering a shopping list for the user.

FIG. 2 is a block diagram of exemplary data structures useful in administering a shopping list for the user.

FIG. 3 is a computer architecture diagram illustrating an exemplary method for administering a shopping list for a user.

FIG. 4 is a computer architecture diagram illustrating another exemplary method of administering a shopping list for a user.

### DETAILED DESCRIPTION OF EXEMPLARY EMBODIMENTS

### Introduction

Exemplary embodiments are described generally in this specification in terms of methods for administering a shopping list for a user. Persons skilled in the art, however, will recognize that any computer system that includes suitable programming means for operating in accordance with the disclosed methods also falls well within the scope of the present invention.

Suitable programming means include any means for directing a computer system to execute the steps of the method for administering a shopping list for a user. Suitable programming means include, for example, systems including processing units and arithmetic-logic circuits connected to computer memory. Such systems generally have the capability of storing in computer memory programmed steps of methods according to exemplary embodiments for execution by a processing unit. Generally in such systems, computer memory is implemented in many ways as will occur to those of skill in the art, including magnetic media, optical media, and electronic circuits configured to store data and program instructions.

Further, embodiments may be implemented as a computer program product for use with any suitable data processing system. Embodiments of a computer program product may be implemented as a diskette, CD ROM, EEPROM (‘flash’) card, or other magnetic or optical recording media for storage of machine-readable information as will occur to those of skill in that art. Persons skilled in the art will immediately recognize that any computer system having suitable programming means will be capable of executing the steps of methods for administering a shopping list as included in a computer program product. Moreover, persons skilled in the art will recognize immediately that, although many of the exemplary embodiments described in this specification are oriented to software installed on computer hardware, nevertheless, alternative embodiments implemented as firmware or other computing machinery are well within the scope of the present invention.

### Administering a Shopping List for a User

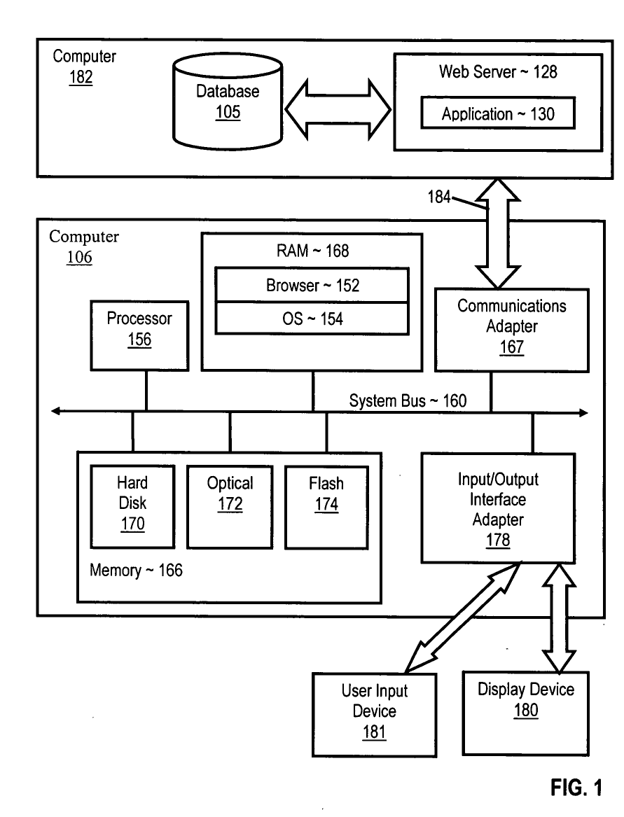

Exemplary methods, systems, and products for administering a shopping list for a user are explained with reference to the accompanying drawings, beginning with FIG. 1. Administering a shopping list for a user is implemented generally by receiving, from a user, a user ID and retrieving, in dependence upon the user ID, a user purchase history. A user purchase history is typically a data structure representing a previous shopping experience for the user. A user purchase history typically includes a list of items purchased by the user during the previous shopping experience. Administering a shopping list for a user also typically includes creating a shopping list for the user in dependence upon a user purchase history, and sending the shopping list to the user. A shopping list is typically a data structure including a list of items sold at the store. The shopping list is typically available for download and use by the user at the store.

The exemplary architecture of FIG. 1 includes a computer (106). A “computer” is any automated computing machinery. The term “computer” as used in this specification therefore includes not only general purpose computers such as laptops, personal computer, minicomputers, and mainframes, but also includes devices such as personal digital assistants (“PDAs), network enabled handheld devices, internet-enabled mobile telephones, and so on.

The computer (106) of FIG. 1 includes at least one computer processor (156) or ‘CPU’ as well as random access memory (“RAM”) (168). Stored in RAM (168) is an operating system (154). Operating systems useful in administering a shopping list for a user include Unix, Linux™, Microsoft NT™, and others as will occur to those of ordinary skill in the art.

Also stored in RAM (168) is a browser (152). “Browser” means a web browser, a software application for locating and displaying web pages. Browsers typically include both a markup language interpreter, that allows a user to view HTML or other markup documents and access files and software related to those documents. Browsers also typically include web page display routines, and an HTTP communications client. Browsers are operative in web-enabled devices, including wireless web-enabled devices. Browsers in wireless web-enabled devices often are downsized browsers called “microbrowsers.” Microbrowsers in wireless web-enabled devices often support markup languages other than HTML, including for example, WML and HDML. Examples of browser application software include Microsoft Outlook™, Netware Netscape™, and NCSA Mosaic™. A browser advantageously empowers a user to access and edit items included within a shopping list, created for example as an HMTL document, as well as access, download, print a shopping list for use at a store.

The example computer (106) of FIG. 1 includes computer memory (166) coupled through a system bus (160) to the processor (156) and to other components of the computer. Computer memory (166) may be implemented as a hard disk drive (170), optical disk drive (172), electrically erasable programmable read-only memory space (so-called ‘EEPROM’ or ‘flash’ memory) (174), RAM drives (not shown), or as any other kind of computer memory as will occur to those of ordinary skill in the art.

The example computer of FIG. 1 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The example computer (106) of FIG. 1 includes communications adapter (167) that implements connections for data communications (184) to other computers such as the computer (182) supporting a web server (128) and a database (105). Communications adapters implement the hardware level of data communications connections through which client computers and servers send data communications directly to one another and through networks. Examples of communications adapters include modems for wired dial-up connections, Ethernet (IEEE 802.3) adapters for wired LAN connections, and 802.11 adapters for wireless LAN connections.

A web server (128) typically includes software that delivers or “serves up” web pages or other documents viewable with a client device such as a web browser. Examples of web server software include software from NCSA, Apache, Microsoft, and Netscape.

The database (105) of FIG. 1 includes data storage for user account information for typical shopping list services. Typical databases useful in administering a shopping list for a user include user records containing user IDs and other user information, a user's purchase history including items a user has previously purchased, a current shopping list for the user, as well as item and store records containing information about particular items and the items location within a particular store.

The web server (128) of FIG. 1 includes shopping list application software (130) that receives, from a user, a user ID and retrieves, in dependence upon the user ID, a user purchase history from the database (105). The user purchase history typically includes a list of previously purchased items. The shopping list application software (130) of FIG. 1 also typically creates a shopping list for a user in dependence upon the user purchase history and sends the shopping list to the user. In some embodiments, the shopping list application creates a shopping list directly from the user purchase history by retrieving an item list of previously purchased items and inserting the items in a shopping list. In other embodiments, the shopping list application empowers a user to edit the item list of a user's purchase history and includes the edited item list in a shopping list.

Many examples of administering a shopping list are described herein using client server architecture and with reference to creating and viewing markup documents such as HTML documents. Such examples are provided for explanation and not limitation. Shopping lists can be administered using many other architectures, such as peer-to-peer, and using various other data structures. All such alternative architectures and alternative data structures are included within the scope of the present invention.

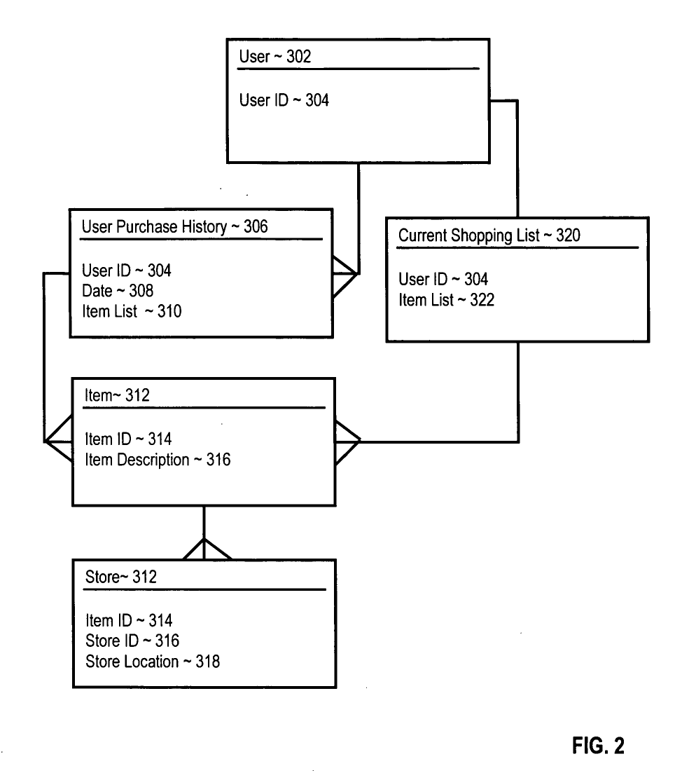

FIG. 2 is a block diagram illustrating data structures useful in administering a shopping list. The block diagram of FIG. 2 includes a user record (302). Typical user records represent the user and include a user ID field (304) uniquely identifying the user.

The block diagram of FIG. 2 includes a user purchase history (306). The user purchase history represents a previous shopping experience by the user. In the example of FIG. 2, a plurality of user purchase history records, each representing a separate shopping experience, are related many-to-one to a user record through the user ID field (304) used as a foreign key. A user purchase history typically includes an item list (310). The item list includes a list of item IDs identifying items purchased on a particular previous shopping trip. That is, the item list is in effect a user's previous shopping list. The item list can be implemented as an object such as a Java list continuer or hash table of item IDs, or any other data structure that will occur to those of skill in the art. In some examples, the item list for a user purchase history record is created when the user checks out at the store. In some such examples, the items are identified by a bar code reader or the like used to scan the purchased items when the user checks out. In some examples, the items are associated with the user's user ID, inserted into a user purchase history record, and stored in database.

The user purchase history of FIG. 2 also includes a date field (308). The date field identifies the date of the user's previous shopping experience. The date field facilitates retrieving a user purchase history according to a date range. For example, a user may wish to create a current shopping list for the first of the month using a user purchase history record having a date field near the first of a month by adding or deleting items from the retrieved user purchase history.

In various alternative embodiments, a user purchase history is used in different ways to create a shopping list. In some embodiments, a user purchase history is used to create a shopping list directly from a user purchase history record. Consider a user who shops at a grocery store on the first and fifteenth of every month and typically buys the same items. The user arrives at the grocery store and uses a computer at the grocery store to access the store's shopping list service. The user provides a user ID to shopping list service and receives a shopping list containing the items included in a user purchase history record that most closely matches the current day of the month.

Another way of using a user purchase history to create a shopping list includes using the items in the purchase history as a base list and allowing the user to edit those items to create a current shopping list. Consider the example of a user who shops at a grocery store only once a month. The user buys different items each time the user shops. The user accesses the grocery store's shopping list service using a web browser at home and retrieves an item list of the most recent user purchase history record. The user deletes items from the list and selects additional items for inclusion in a new current shopping list. The user can then arrive at the store and using a browser at a kiosk in the store access the store's shopping list service and request a shopping list including the user's selected items. In such examples, the shopping list is created in dependence upon a user purchase history.

The block diagram of FIG. 2 includes a current shopping list (320). A current shopping list is a data structure including an item list (322) designating items that should be included in a shopping list for the user's next shopping trip. The current shopping list is related one-to-one with the user record (302) through the user ID field used as a foreign key.

The block diagram of FIG. 2 includes an item record (312). An item record (312) typically represents an item sold at the store. The item record (312) is related many-to-one to the purchase history record (306) and the current shopping list record (if one has been created) through the item ID field (314) used as a foreign key. The item record (312) of FIG. 2 also includes an item description (316) field including a description of the item. Item descriptions can include a text description of the item, nutritional content of the item or any item description that will occur to those of ordinary skill in the art.

The block diagram of FIG. 2 includes a store record (312). The store record (312) is related many-to-one to the item record through the item ID field (314) used as a foreign key. The store record (312) typically includes a store ID (316) field uniquely identifying a particular store having the item in stock or that typically carries the related item. The store record of FIG. 2 also includes a store location field (318). The store location field (318) contains the location of the item within that store. In some embodiments, a store location (318) includes the isle number where the item is located within the store.

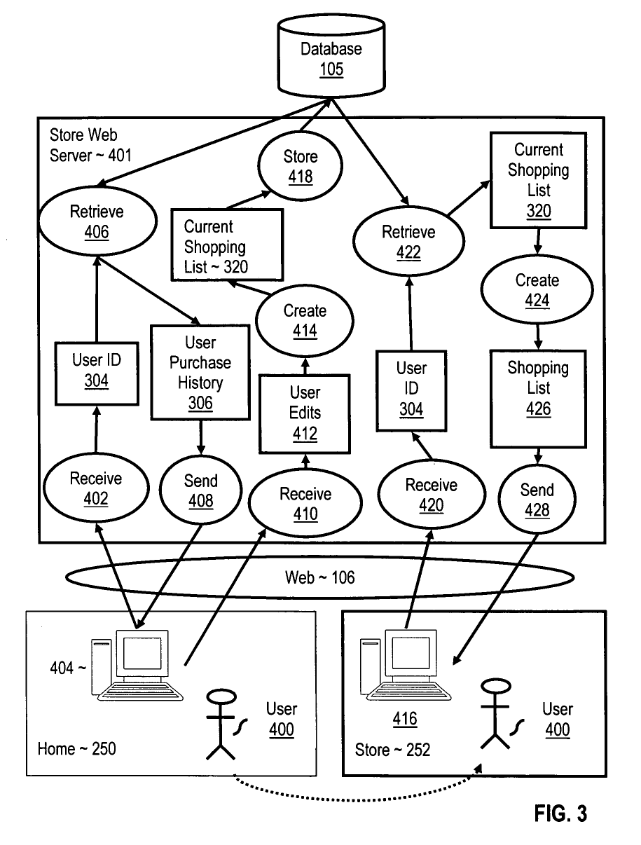

FIG. 3 is a computer architecture diagram illustrating an exemplary method for administering a shopping list for a user. The method of FIG. 3 includes receiving (402), from an input device (404), a user ID (304) for the user (400). A user ID is any ID uniquely identifying the user. Typical user IDs includes an alphanumeric code, an email address, a first name, last name, phone number, or any other ID that will occur to those of ordinary skill in the art. In some examples, a user may select a user ID or selects a user ID when the user registers with a store and creates a shopping list service account with the store.

In some examples of the method of FIG. 3, receiving (402), from an input device (404), a user ID (304) is carried out by application software running on a store's web server (401). Using a web browser a user can access instruction screens prompting the user to enter a user ID to gain access to a shopping list service.

The exemplary method of FIG. 3 includes retrieving (406), in dependence upon the user ID (304), a user purchase history (306) from a database (105). As discussed above, a user purchase history is a data structure including a list of items the user previously purchased during the user's last shopping experience, during the user's previous shopping experience around the same time period (e.g., beginning of the month), or during two or more shopping experiences (where all of the items are collected). User purchase histories are typically stored in a database such as the database (105) of FIG. 3. In many examples of the method of FIG. 3, retrieving (406), in dependence upon the user ID (304), a user purchase history (306) is carried out by application software running on the store's web server using CGI scripts, Java servlets or the like.

In many embodiments, retrieving, in dependence upon the user ID, a user purchase history includes retrieving, in dependence upon the date, a user purchase history. Retrieving a user purchase history in dependence upon the current date often results in retrieving a user purchase history containing an item list that is currently appropriate for the user. That is, shoppers often routinely shop for the same items may use a date appropriate user purchase history as a base shopping list to create a current shopping list with minimal editing.

In some examples of the method of FIG. 3, each time a user shops at the store the items the user actually purchased are identified (using for example a bar code reader used to scan the items when the user checks out) and stored as an item list in a user purchase history record. In some examples, the user purchase history records are then uploaded to the stores' web server and stored in a database.

If a user has not previously used the shopping list service or previously shopped at the store, a user may not have a user purchase history. In some such examples, a generic user purchase history may be retrieved the first time the user accesses the shopping list service or a user may be prompted to create a user purchase history by selecting particular items from a list of items carried by the store.

The method of FIG. 3 includes incorporating the item list of the user purchase history into a data structure and sending (408) the document to the user (400). Typically, the item list is incorporated in to an HTML document or other markup document and sent to the user's client device (such as a web browser (404)) as an HTTP message.

Using a browser installed on a home computer (404), the user is empowered to view the document including the user purchase history's item list. Through one or more instruction screens designed to facilitate editing the item list, a user can edit the item list of the user purchase history by adding or deleting items. Such instruction screens can be HTML documents that include buttons for adding and deleting items and descriptions of items carried by the store.

The method of FIG. 3 includes receiving (410) the user edits (412). In some examples of the method of FIG. 3, the user edits are received from the user's client device (404) such as a web browser as a data encoded URI. The user edits are parsed from the data encoded URI to create an edited item list.

The method of FIG. 3 includes creating (414) a current shopping list (320) in dependence upon the edited item list of the user purchase history and storing (418) the current shopping list (416) in a database (105) for the user. A current shopping list is a data structure including the edited item list. Typically, storing the current shopping list is carried out by application software on the store's web server using CGI scripts, Java servlets, or the like.

A user can and often will access and edit the current shopping list prior to shopping at the store. Allowing a user to access and edit the current shopping list online any time prior to shopping advantageously provides flexibility in deciding which items the user needs to purchase during the next shopping trip. A user may add items one item at a time when the user identifies a desire for the item. Furthermore, the user's family member can also access and edit the current shopping list reducing the need for any one member to create the shopping list for the family.

Having created a current shopping list, in the method of FIG. 3, the user (400) travels to the store (252). While at the store, a user accesses the shopping list service. One way of accessing the shopping list service is by directing a client device such as a browser (416) installed on a computer located within the store to the store's web server (402).

The method of FIG. 3 includes receiving (420), from the user (400), a user ID (304) and retrieving (422) the current shopping list (320) in dependence upon the user ID. The current shopping list includes the customized list of items for the current shopping trip. In many examples of the method of FIG. 3, retrieving (422) the current shopping list (320) in dependence upon the user ID is carried out by application software running on the store's web server using CGI scripts, Java servlets or the like.

The method of FIG. 3 includes creating (424) a shopping list for the user. A shopping list is a data structure including at least a plurality of items sold at the store. In many examples of the method of FIG. 3, creating a shopping list includes retrieving an HTML shopping list form and inserting the item list of the current shopping list into the HTML shopping list form.

Shopping lists can and often do include more than a list of items. In many embodiments, creating a shopping list for the user includes retrieving a store location of an item and inserting the store location of the item in the shopping list. In many examples of the method of FIG. 3, the store location is retrieved from a store record in a relational database and inserted into the shopping list form. In typical embodiments, retrieving a store location of an item and inserting the store location of the item in the shopping list is carried out by application programming on the stores web server using CGI scripts, Java serves, or the like.

In some examples of the method of FIG. 3, creating a shopping list for the user includes inserting a coupon into the shopping list. In some examples, a coupon for a particular item included in the shopping list is retrieved from a database and inserted into the shopping list. Inserting coupons into the shopping list advantageously provides the user with coupons the user will use and provides the store or manufacturer a mechanism to send coupons only to customers who will use them. Furthermore, inserting the coupons into the shopping list removes the requirement of the user to remember and bring the coupons to the store.

In some examples of the method of FIG. 3, creating a shopping list includes prioritizing at least one of a plurality of shopping items. In some examples of the method of FIG. 3, prioritizing at least one of a plurality of items includes sorting the plurality items in the item list. In some examples, the items are sorted in dependence upon the location of the items in the store to provide a list of items that is convenient to retrieve. Such a sorted item list can increase a user's shopping efficiency by minimizing the distance a user must travel to retrieve the items and reduce the need to backtrack to retrieve a missed or forgotten item. In other examples, the items are sorted by price to highlight to the user the most expensive items. Such sorted item list can be useful to a user on a budget.

In some examples of the method of FIG. 3, creating a shopping list for the user includes inserting an advertisement in the shopping list. Some such examples include retrieving an advertisement from a database in dependence upon an item in the shopping list. The advertisement inserted into the shopping list can vary from advertisement for items similar to those in the shopping list, advertisements for products made by a competitor of the manufacturers of the items in the shopping list, advertisement unrelated to the shopping list or any other advertisement that will occur to those of skill in the art.

In some examples, creating a shopping list includes suggesting an item not included in the user purchase history or current shopping list. Some such examples include retrieving a suggested item from a database in dependence upon the items that are included in the user purchase history or current shopping list and inserting the suggested item in the shopping list. A suggested item can be a nutritious alternative to an item included in the user purchase history or current shopping list or an alternative item that is in stock when an item included in the user purchase history or current shopping list is not in stock.

In some examples of the method of FIG. 3, creating a shopping list includes identifying at least one grocery item in the shopping list that is on sale. One way of identifying sale items is by comparing the items in the shopping list with a list of items on sale to identify items within the shopping list on sale and highlighting particular sale items on the shopping list.

The method of FIG. 3 includes sending (428) the shopping list to the user. In some examples, the shopping list is sent to a user's client device as an HTML document in an HTTP message. Having received the shopping list, the user can print the shopping list and use it to shop. In an alternative example, a user can receive the shopping list on a client device such as a PDA reducing the need to print the shopping list.

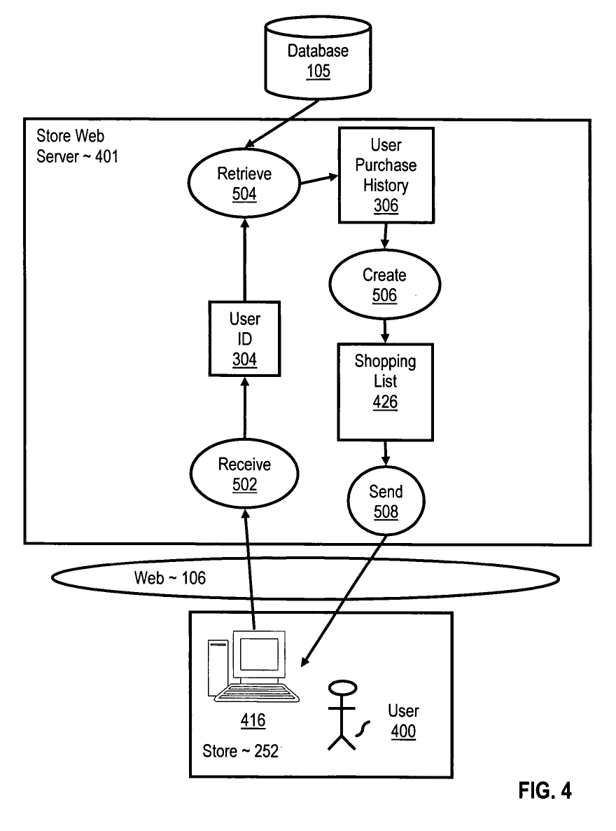

In the method of FIG. 3, a shopping list is created directly in dependence upon a current shopping list and indirectly in dependence upon the user purchase history. In some cases however a user may not create a current shopping list. FIG. 4 is data flow diagram of another method for administering a shopping list where a user has not created a current shopping list. In the method of FIG. 4, a user arrives at the store without having created a current shopping list. The user can access the store's shopping list service by for example, logging onto the store's web server using a client device located within the store.

The method of FIG. 4 includes receiving (502), from the user (400), a user ID (304) and retrieving (504) a user purchase history (320) in dependence upon the user ID. As discussed above a user purchase history is a data structure including a list of items the user purchased in a previous shopping experience. In many examples of the method of FIG. 3, retrieving, in dependence upon the user ID, a user purchase history is carried out by application software running on the store's web server using CGI scripts, Java servlets or the like.

In many embodiments, retrieving, in dependence upon the user ID, a user purchase history includes retrieving, in dependence upon the date, a user purchase history. Retrieving a user purchase history in dependence upon the current date often results in retrieving a user purchase history containing an item list that is currently appropriate for the user. That is, shoppers often routinely shop for the same items. Therefore, a user who consistently purchases the same items near the same days of the month can retrieve a useful shopping list without having to create a new current shopping list each time the user goes the store.

The method of FIG. 4 includes creating (424) a shopping list for the user in dependence upon the user purchase history. A shopping list is a data structure including at least a plurality of items sold at the store. In many examples of the method of FIG. 4, creating a shopping list includes retrieving an HTML shopping list form and inserting the item list of the user purchase history into the HTML shopping list form. As discussed above, shopping lists can and often do include more than a list of items. In many embodiments, creating a shopping list for the user includes retrieving a store location of an item and inserting the store location of the item into the shopping list, inserting a coupon into the shopping list, prioritizing an item, sorting a plurality of items in the item list, inserting an advertisement in the shopping list, suggesting an alternative item not included in the shopping list, or identifying an item in the shopping list that is on sale.

The method of FIG. 4 includes sending (508) the shopping list (426) to the user (400). In some examples, the shopping list is sent to a user's client device as an HTML document in an HTTP message. Having received the shopping list, the user can print the shopping list and use it to shop. In an alternative example, a user can receive the shopping list on a client device such as a PDA reducing the need to print the shopping list.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A computer-implemented method for administering a shopping list for a user, the method comprising:
receiving, from an input device, a user ID of the user;
retrieving, in dependence upon the user ID, a user purchase history from a database;
creating, by a processor, a shopping list for the user in dependence upon the user purchase history; and
sending, by the processor, the shopping list to the user.

2. The method of claim 1 wherein retrieving a user purchase history comprises retrieving, in dependence upon the current date, a user purchase history that substantially repeats on or near the current date.

3. The method of claim 1 wherein creating a shopping list for the user in dependence upon a user purchase history comprises retrieving a store location of an item and inserting the store location of the item in the shopping list.

4. The method of claim 1 wherein creating a shopping list for the user in dependence upon a user purchase history comprises inserting a coupon in the shopping list.

5. The method of claim 1 wherein creating a shopping list for the user in dependence upon a user purchase history comprises inserting an advertisement in the shopping list.

6. The method of claim 5 wherein the advertisement comprises an advertisement for an item not included in the user purchase history.

7. The method of claim 1 wherein creating a shopping list comprises prioritizing at least one of a plurality of shopping items.

8. The method of claim 7 wherein prioritizing at least one of a plurality of shopping items comprises prioritizing at least one of a plurality of shopping items in dependence upon a store location of the shopping item.

9. The method of claim 7 wherein prioritizing at least one of a plurality of shopping items comprises prioritizing at least one of a plurality of shopping items in dependence upon the price of the shopping item.

10. The method of claim 1 wherein creating a shopping list for the user in dependence upon a user purchase history comprises inserting a suggested item into the shopping list.

11. The method of claim 10 wherein inserting a suggested item into the shopping list comprises inserting an alternative item in the shopping list in dependence upon an item in the user purchase history.

12. The method of claim 10 wherein inserting a suggested item into the shopping list comprises inserting an item in the shopping list that is in stock in dependence upon an item in the user purchase history that is out of stock.

13. A computer system for administering a shopping list for a user, the system comprising:
input device for receiving, from a user, a user ID;
a processor for retrieving, in dependence upon the user ID, a user purchase history from a database;
the processor for creating a shopping list for the user in dependence upon a user purchase history; and
the processor for sending the shopping list to the user.

14. The computer system of claim 13 wherein a processor for retrieving a user purchase history comprises a processor for retrieving, in dependence upon the current date, a user purchase history that substantially repeats on or near the current date.

15. The computer system of claim 13 wherein the processor for creating a shopping list for the user in dependence upon a user purchase history comprises a processor for retrieving a store location of an item and a processor for inserting the store location of the item in the shopping list.

16. The computer system of claim 13 wherein the processor for creating a shopping list for the user in dependence upon a user purchase history comprises a processor for inserting a coupon in the shopping list.

17. The computer system of claim 13 wherein the processor for creating a shopping list for the user in dependence upon a user purchase history comprises a processor for inserting an advertisement in the shopping list.

18. The computer system of claim 17 wherein the advertisement comprises an advertisement for an item not included in the user purchase history.

19. The computer system of claim 13 wherein the processor for creating a shopping list comprises a processor for prioritizing at least one of a plurality of shopping items.

20. The computer system of claim 19 wherein a processor for prioritizing at least one of a plurality of shopping items comprises a processor for prioritizing at least one of a plurality of shopping items in dependence upon a store location of the shopping item.

21. The computer system of claim 19 wherein a processor for prioritizing at least one of a plurality of shopping items comprises a processor for prioritizing at least one of a plurality of shopping items in dependence upon the price of the shopping item.

22. The computer system of claim 13 wherein the processor for creating a shopping list for the user in dependence upon a user purchase history comprises a processor for inserting a suggested item into the shopping list.

23. The computer system of claim 22 wherein the processor for inserting a suggested item into the shopping list comprises a processor for inserting an alternative item in the shopping list in dependence upon an item in the user purchase history.

24. The computer system of claim 22 wherein the processor inserting a suggested item into the shopping list comprises a processor for inserting an item in the shopping list that is in stock in dependence upon an item in the user purchase history that is out of stock.

25. A computer program product for administering a shopping list for a user, the computer program product comprising:
a recording medium;
means, recorded on the recording medium, for receiving, from an input device, a user ID of the user;
means, recorded on the recording medium, for retrieving, in dependence upon the user ID, a user purchase history from a database;
means, recorded on the recording medium, for creating, by a processor, a shopping list for the user in dependence upon the user purchase history; and
means, recorded on the recording medium, for sending, by the processor, the shopping list to the user.

26. The computer program product of claim 25 wherein means, recorded on the recording medium, for retrieving a user purchase history comprises means, recorded on the recording medium, for retrieving, in dependence upon the current date, a user purchase history that substantially repeats on or near the current date.

27. The computer program product of claim 25 wherein means, recorded on the recording medium, for creating a shopping list for the user in dependence upon a user purchase history comprises means, recorded on the recording medium, for retrieving a store location of an item and inserting the store location of the item in the shopping list.

28. The computer program product of claim 25 wherein means, recorded on the recording medium, for creating a shopping list for the user in dependence upon a user purchase history comprises means, recorded on the recording medium, for inserting a coupon in the shopping list.

29. The computer program product of claim 25 wherein means, recorded on the recording medium, for creating a shopping list for the user in dependence upon a user purchase history comprises means, recorded on the recording medium, for inserting an advertisement in the shopping list.

30. The computer program product of claim 29 wherein the advertisement comprises an advertisement for an item not included in the user purchase history.

31. The computer program product of claim 25 wherein means, recorded on the recording medium, for creating a shopping list comprises means, recorded on the recording medium, for prioritizing at least one of a plurality of shopping items.

32. The computer program product of claim 31 wherein means, recorded on the recording medium, for prioritizing at least one of a plurality of shopping items comprises means, recorded on the recording medium, for prioritizing at least one of a plurality of shopping items in dependence upon a store location of the shopping item.

33. The computer program product of claim 31 wherein means, recorded on the recording medium, for prioritizing at least one of a plurality of shopping items comprises means, recorded on the recording medium, for prioritizing at least one of a plurality of shopping items in dependence upon the price of the shopping item.

34. The computer program product of claim 25 wherein means, recorded on the recording medium, for creating a shopping list for the user in dependence upon a user purchase history comprises means, recorded on the recording medium, for inserting a suggested item into the shopping list.

35. The computer program product of claim 34 wherein means, recorded on the recording medium, for inserting a suggested item into the shopping list comprises means, recorded on the recording medium, for inserting an alternative item in the shopping list in dependence upon an item in the user purchase history.

36. The computer program product of claim 34 wherein means, recorded on the recording medium, for inserting a suggested item into the shopping list comprises means, recorded on the recording medium, for inserting an item in the shopping list that is in stock in dependence upon an item in the user purchase history that is out of stock.
